(19) United States
(12) Patent Application Publication
(10) Pub. No.: US 2025/0163245 A1
(43) Pub. Date: May 22, 2025

(54) ARTICLE COMPRISING AN OBJECT AND A LAYER

(71) Applicant: SABIC GLOBAL TECHNOLOGIES B.V., Bergen op Zoom (NL)

(72) Inventors: Robert Walter VENDERBOSCH, Bergen op Zoom (NL); Roland VAN GIESEN, Nederweert (NL); Petya Dochkova YANEVA, Maastricht (NL)

(21) Appl. No.: 18/724,794

(22) PCT Filed: Dec. 22, 2022
(86) PCT No.: PCT/EP2022/087592

§ 371 Date: Jun. 27, 2024

(30) Foreign Application Priority Data
Dec. 28, 2021 (EP) 21217922.0

(51) Int. Cl. C08K 7/14; C08J 7/04; C08L 23/12; C08L 23/16

(52) U.S. Cl. CPC C08K 7/14; C08J 7/0427; C08L 23/12; C08L 23/16; C08J 2323/12; C08J 2323/16; C08J 2479/02; C08K 2201/004

(57) ABSTRACT

An article has an object and a layer, the object contains a thermoplastic composition including a thermoplastic and glass fibers wherein the glass fibers have an average length of at least 0.36 mm, and the layer includes compounds having moieties derived from melamine and pentaerythritol. The article has superior flame retardant performance.

### CROSS REFERENCE TO RELATED APPLICATIONS

This application is a National Stage application of PCT/EP2022/087592, filed Dec. 22, 2022 which claims the benefit of European Application No. 21217922.0, filed Dec. 28, 2021, both of which are incorporated by reference in their entirety herein.

### BACKGROUND

The present invention relates to an article comprising an object and a layer, the object comprise a thermoplastic composition wherein the thermoplastic composition comprise thermoplastic composition comprising a thermoplastic and glass fibers wherein the glass fibers have an average length of at least 0.36 mm. The present invention further relates to a process for the preparation of the article. The present invention further relates to the use of the article.

The use of a thermoplastic composition in building and construction is known in the art. For example, CN204456839U discloses a kind of hollow polypropylene carrying wall with thermal insulating function. Thermoplastic composition with flame retardant functionality in building and construction is also known in the art, e.g. U.S. Pat. No. 6,777,466B2 discloses a flame retardant thermoplastic polyurethane containing melamine cyanurate, EP2937387 discloses a flame retardant thermoplastic polyurethane (TPU) compositions that are prepared by compounding certain TPUs and with a polyphosphonate polymer.

There is still need to have an article with superior flame retardant performance, and the article shall be suitable for use in building and construction.

### SUMMARY

This need is satisfied by an article comprising an object and a layer, wherein at least part of the surface of the object is covered by the layer, wherein the object comprises a thermoplastic composition, wherein the thermoplastic composition comprises a thermoplastic and glass fibers wherein the glass fibers have an average length of at least 0.36 mm, wherein the layer comprises compounds comprising moieties derived from melamine and pentaerythritol . . .

### DETAILED DESCRIPTION

The inventor of the present invention surprisingly found that the glass fibers with an average length of at least 0.36 mm and the layer comprises compounds comprising moieties derived from melamine and pentaerythritol have a synergistic effect and lead to a superior flame retardant performance of the article. In the contact of the present invention. “superior flame retardant performance” means the article passes Single Burning Item (SBI) test EN 13501-1:2018.

### Coating and Layer

The coating according to the present application is typically provided in liquid form at room temperature.

The coating comprises compounds comprising moieties derived from melamine and pentaerythritol. In the context of the present invention, “compounds comprising moieties derived from melamine and pentaerythritol” is to be understood as compounds comprising moieties derived from melamine and compounds comprising moieties derived from pentaerythritol.

The compounds comprising moieties derived from melamine is preferably selected from the list consisting of melamine phosphate, melamine cyanurate, melamine borate, melamine polyphosphate, melamine silicate and mixtures thereof; The compounds comprising moieties derived from pentaerythritol is preferably selected from the list consisting of pentaerythritol, dipentaerythritol, tripentaerythritol, polycondensates of pentaerythritol, pentaerythritol-based esters and mixtures thereof.

Preferably the amount of the compounds comprising moieties derived from melamine is in the range from 10 to 70 wt %, preferably from 20 to 50 wt % based on the total amount of the coating. Preferably the amount of the compounds comprising moieties derived from pentaerythritol is in the range from 5 to 35 wt %, preferably from 10 to 30 wt % based on the total amount of the coating.

Preferably the coating further comprises compounds comprising moieties derived from phosphate, the compounds comprising moieties derived from phosphate is preferably selected from the list consisting of guanyl urea phosphate, sodium polyphosphate and mixtures thereof. It was found by the inventors of the present application that the preferred compounds comprising moieties derived from phosphate has superior flame resistance than other compounds comprising moieties derived from phosphate. e.g. ammonium salts of phosphoric acids and/or polyphosphoric acids, ammonium polyphosphates.

Preferably the amount of the compounds comprising moieties derived from phosphate is in the range from 5 to 35 wt %, preferably from 10 to 30 wt % based on the total amount of the coating.

The coating according to the present application preferably further comprises 15 to 20 wt % water.

Preferably the total amount of water, compounds comprising moieties derived from melamine, pentaerythritol and phosphate is at least 90 wt %, preferably at least 95 wt %, more preferably at least 98 wt %, most preferably 100 wt % based on the total amount of the coating. In the present invention for the purpose of avoiding any confusion upon identifying the amount of each compound, compounds comprising moieties derived from both melamine and phosphate is counted as compounds comprising moieties derived from melamine.

The coating according to the invention preferably has a density in the range from 1080 to 1534 kg/m3, preferably from 1090 to 1380 kg/m3 as measured according to ISO 18747-2:2019.

A suitable coating according to the invention is for example Envirograf HW01-EP-GC.

At least part of the surface of an object is covered by the coating after the application of the coating, this part of the surface is referred as coated part. The coating can be applied to the object for example using a roller or a brush, alternatively the coating can be applied by spraying the coating on the object. The amount of coating to be applied on the coated part of the object is preferably in the range from 0.08 to 0.23 L/m2, preferably in the range from 0.11 to 0.18 L/m2.

After drying at room temperature 23° C., 50% relative humidity, 7 days, the coating is completely dried and will be further referred as a layer in the current application. At least part of the surface of the object is covered by the layer. The layer preferably has a thickness in the range from 150 to 2450 μm, preferably from 190 to 1660 μm, more preferably from 235 to 980 μm, even more preferably from 256 to 461 μm. The amount of layer on the part of the surface covered by the layer is in the range from 0.05 to 0.19 kg/m2, preferably in the range from 0.09 to 0.16 kg/m2, more preferably in the range from 0.10 to 0.13 kg/m2.

The layer comprises compounds comprising moieties derived from melamine, pentaerythritol and preferably phosphate. The compounds comprising moieties derived from melamine is preferably selected from the list consisting of melamine phosphate, melamine cyanurate, melamine borate, melamine polyphosphate, melamine silicate and mixtures thereof; The compounds comprising moieties derived from pentaerythritol is preferably selected from the list consisting of pentaerythritol, dipentaerythritol, tripentaerythritol, polycondensates of pentaerythritol, pentaerythritol-based esters and mixtures thereof; The compounds comprising moieties derived from phosphate is preferably selected from the list consisting of guanyl urea phosphate, sodium polyphosphate and mixtures thereof. It was found by the inventors of the present application that the preferred compounds comprising moieties derived from phosphate has superior flame resistance than other compounds comprising moieties derived from phosphate, e.g. ammonium salts of phosphoric acids and/or polyphosphoric acids, ammonium polyphosphates.

Preferably the amount of the compounds comprising moieties derived from melamine is in the range from 13 to 88 wt %, preferably from 25 to 63 wt % based on the total amount of the coating. Preferably the amount of the compounds comprising moieties derived from pentaerythritol is in the range from 8 to 44 wt %, preferably from 13 to 38 wt % based on the total amount of the coating. Preferably the amount of the compounds comprising moieties derived from phosphate is in the range from 8 to 44 wt %, preferably from 13 to 38 wt % based on the total amount of the coating.

Preferably the total amount compounds comprising moieties derived from melamine, pentaerythritol and phosphate at least 90 wt %, preferably at least 95 wt %, more preferably at least 98 wt %, most preferably 100 wt % based on the total amount of the layer. In the present invention for the purpose of avoiding any confusion upon identifying the amount of each compound, compounds comprising moieties derived from both melamine and phosphate is counted as compounds comprising moieties derived from melamine.

### Object and Thermoplastic Composition

### Thermoplastic Composition

The thermoplastic composition according to the present invention comprises a thermoplastic and glass fibers. Preferably the thermoplastic composition further comprise a flame retardant composition.

The amount of the glass fiber is preferably in the range from 15 to 56 wt %, preferably from 21 to 45 wt %, more preferably from 25 to 37 wt % based on the total amount of the thermoplastic composition.

The amount of the thermoplastic is preferably in the range from 24 to 69 wt %, preferably from 36 to 67 wt %, more preferably from 45 to 65 wt % based on the total amount of the thermoplastic composition.

The amount of the flame retardant composition is preferably in the range from 18 to 34 wt %, preferably from 21 to 29 wt %, based on the total amount of the thermoplastic composition.

The thermoplastic composition according to the invention may further comprise up to 7 wt % common additives, e.g. compatibilizer, coupling agent, anti-oxidant, colorant, etc. In avoidance of any confusion, glass fibers, thermoplastic and flame retardant composition are not common additives.

The thermoplastic composition is preferably prepared by a process for the preparation of a composition reinforced by long glass fibers, e.g. so-called wire-coating process as disclosed in WO2009/080281, or a pultrusion process as disclosed in U.S. Pat. No. 6,872,343B2 and WO2001024993A1.

After preparation, the thermoplastic composition is typically in pellet form for further processing, e.g. shaping. The pellet of the thermoplastic composition is typically in cylindrical shape wherein the glass fibers essentially extend along the length of the pellet which is geometrically the height of the cylindrical shape.

### Thermoplastic

The thermoplastic according to the invention can be any suitable thermoplastic to used as a panel in building & construction, preferably the thermoplastic is a polypropylene, e.g. a propylene homopolymer or a heterophasic propylene copolymer.

The MFI of the polypropylene is preferably in the range from 0.5 to 78 g/10 min, more preferably in the range from 1.2 to 65 g/10 min, even more preferably from 1.6 to 55 g/10 min as measured according to ISO1133 at 230°, 2.16 kg.

The polypropylene according to the invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably the polypropylene comprises PP1 and PP2, wherein PP1 is a propylene homopolymer and/or PP2 is a heterophasic propylene copolymer, wherein PP1 has an MFI in the range from 15 to 65 g/10 min. preferably in the range from 22 to 54 g/10 min as measured according to ISO1133 at 230°, 2.16 kg, wherein PP2 has an MFI in the range from 0.3 to 5.6 g/10 min, preferably in the range from 0.9 to 1.7 g/10 min as measured according to ISO1133 at 230°, 2.16 kg. The combination of PP1 and PP2 would lead to a superior balance between stiffness and toughness.

### Flame Retardant Composition

The flame retardant composition according to the present invention is preferably a halogen-free flame retardant composition.

The halogen-free flame retardant composition may comprise an organophosphorus compound.

Preferably, the organophosphorus compound is selected from the group consisting of melamine phosphate, melamine polyphosphate, melamine pyrophosphate, piperazine phosphate, piperazine polyphosphate, piperazine pyrophosphate, 2-methylpiperazine monophosphate, tricresyl phosphate, alkyl phosphates, tetraphenyl pyrophosphate, poly(2-hydroxy propylene spirocyclic pentaerythritol bisphosphate) and poly(2,2-dimethylpropylene spirocyclic pentaerythritol bisphosphonate) and combinations thereof.

More preferably, the organophosphorus compound is selected from the group consisting of melamine phosphate, melamine polyphosphate, melamine pyrophosphate, piperazine phosphate, piperazine polyphosphate, piperazine pyrophosphate and 2-methylpiperazine monophosphate and combinations thereof.

In some embodiments, the organophosphorus compound comprises a first compound selected from melamine phosphate, melamine polyphosphate and melamine pyrophosphate a second compound selected from piperazine phosphate, piperazine polyphosphate, piperazine pyrophosphate and 2-methylpiperazine monophosphate.

The weight ratio between the first compound and the second compound may e.g. be 1:5 to 5:1, for example 1:5 to 1:1 or 1:1 to 5:1.

The halogen-free flame retardant composition may further comprise zinc oxide and/or ammonium polyphosphate.

Preferably, the amount of zinc oxide in the halogen-free flame retardant composition with respect to the total amount of the organophosphorus compound, zinc oxide and ammonium polyphosphate is 1.0 to 10 WE %.

The halogen-free flame retardant composition may further comprise ammonium polyphosphate.

Preferably, the amount of ammonium polyphosphate in the halogen-free flame retardant composition with respect to the total amount of the organophosphorus compound, zinc oxide and ammonium polyphosphate is 5.0 to 15 wt %.

In some embodiments, the halogen-free flame retardant composition comprises particles comprising
a first compound selected from melamine phosphate, melamine polyphosphate and melamine pyrophosphate,
a second compound selected from piperazine phosphate, piperazine polyphosphate, piperazine pyrophosphate and 2-methylpiperazine monophosphate.
zinc oxide and
ammonium polyphosphate,
wherein
the amount of the first compound, for example melamine phosphate, is 50 to 80 wt %.
the amount of the second compound, for example piperazine phosphate, is 10 to 25 wt % and
the amount of zinc oxide is 1.0 to 10 wt %.
the amount of the ammonium polyphosphate is 5.0 to 15 wt %.
with respect to the particles.

Preferably, the amount of the particles with respect to the total composition is 15 to 40 wt %.

In some embodiments, the halogen-free flame retardant composition further comprises an aromatic phosphate ester. Preferably, the amount of the aromatic phosphate ester flame retardant is 0.1 to 15 wt % with respect to the total composition.

Preferably, the aromatic phosphate ester is selected from the group consisting of resorcinol bis(diphenyl phosphate); tetraphenyl resorcinol bis(diphenylphosphate); bisphenol A bis(diphenyl phosphate); bisphenol A diphosphate; resorcinol bis(di-2,6-xylyl phosphate), phosphoric acid, mixed esters with [1,1′-biphenyl]-4-4′-diol and phenol; phosphorictrichloride, polymer with 1,3-benzenediol,phenylester; 1,3-phenylene-tetrakis(2,6-dimethylphenyl)diphosphate; isopropenylphenyl diphenyl phosphate; 4-phenylphenolformaldehyde phenylphosphonate; tris(2,6-xylyl)phosphate; resorcinol bis(di-2,6-xylyl phosphate); bisphenol S bis(diphenyl phosphate); resorcinol-bisphenol A phenyl phosphates.

Preferably, the aromatic phosphate ester is added as a liquid.

Preferably, the aromatic phosphate ester is bisphenol A bis(diphenyl phosphate).

For example Adeka FP2500 is a flame retardant composition according to the invention.

### Glass Fibers

Glass fibres according to the invention may be provided in the form of individual filament or in the form of as a plurality of continuous filaments, and can be in the form of strands, rovings or yarns. A filament is an individual glass fiber. A strand is a plurality of bundled filaments. Yarns are collections of strands, for example strands twisted together. A roving refers to a collection of strands wound into a package.

Generally the glass fibers have a cross section in circular shape wherein the circular shape preferably have a diameter of 5 to 50 μm, more preferably from 10 to 30 μm, even more preferably from 15 to 25 μm. Usually the glass filaments are circular in cross section meaning the thickness as defined above would mean diameter. The glass filaments are generally circular in cross section.

During the preparation of the object using the pellet of the thermoplastic composition, the length of the glass fibers may vary.

The length of the glass fibers in the pellets is substantially the same as that of the pellet containing the glass fibers. The average length of glass fibers in the pellets of the thermoplastic composition is preferably in the range of 10 to 55 mm, preferably 10 to 40 mm, more preferably 10 to 30 mm and most preferably from 10 to 20 mm.

Preferably, the ratio between the length of the glass fibers and the diameter of the glass fibers (L/D ratio) in the pellets of the thermoplastic composition is 500 to 1000.

The glass fibers in the object have an average length of at least 0.36 mm, preferably from 0.39 to 5.45 mm, more preferably from 0.39 to 4.0 mm, even more preferably from 0.43 to 2.33 mm, even more preferably from 0.45 to 1.67 mm.

In the context of the present invention, the “average length” of the glass fibers refers to the weight average length of the glass fibers and is calculated using the following equation:

$${L}_{w} = \frac{\sum {l}_{i}^{2}}{\sum {l}_{i}}$$

Wherein L_{w} is the average length of the glass fibers, lᵢ is the individual fiber length.

The individual fiber length of glass fibers in the object and pellets can be measured for example by
incinerating the object or pellets at a temperature of 700° C.,
using a brush to gently spread the ash obtained by incineration,
taking a photo under an optical microscope of the spread ash,
using an image processing algorithm to detect the length of all the individual glass fibers in the image.

Alternatively, the individual fiber length of glass fibers in the object and pellets can also be measured by
using a 3D scan technique e.g. micro CT to create a 3D image of the internal structure of the object or pellets,
using an image processing algorithm to detect the length of all the individual glass fibers in the image.

The individual fiber length of glass fibers in the pellets can also be determined by direct measurement of the pellet length.

### Object

The object according to the invention is preferably in the form of a sheet or a panel wherein the thickness of the sheet or the panel is in the range from 15 to 55 mm, more preferably from 20 to 45 mm, even more preferably from 26 to 43 mm. Such form renders the object suitable to be used in building and construction.

The amount of the thermoplastic composition is at least 90 wt %, preferably at least 95 wt %, more preferably at least 98 wt %, most preferably 100 wt % based on the total amount of the object.

The object according to the invention can be prepared in a known shaping process, e.g. extrusion molding, injection molding.

### Article

The article according to the invention comprises an object and a layer, wherein at least part of the surface of the object is covered by the layer, wherein the object comprises a thermoplastic composition, wherein the thermoplastic composition comprises a thermoplastic and glass fibers wherein the glass fibers have an average length of at least 0.36 mm, wherein the layer comprises compounds comprising moieties derived from melamine and pentaerythritol.

The article according to the invention is prepared in a process comprising the following sequential steps:
a) Providing pellets comprising a thermoplastic composition wherein the thermoplastic composition comprises a thermoplastic and glass fibers, wherein the glass fibers have an average length in the range from 10 to 55 mm, preferably from 10 to 40 mm, more preferably from 10 to 30 mm and most preferably from 10 to 20 mm;
b) Shaping the pellets into an object, preferably by extrusion molding or injection molding;
c) Applying a coating on at least part of the surface of the object, wherein the coating comprises compounds comprising moieties derived from melamine, pentaerythritol and preferably phosphate.

Preferably in step a) the length of the glass fibers in the pellets is substantially the same as the pellet length.

Preferably in step a) the amount of the thermoplastic composition is at least 90 wt %, preferably at least 95 wt %, more preferably at least 98 wt %, most preferably 100 wt % based on the weight of the pellets.

Preferably in step c) the coating is applied on at least part of the surface of the object using a brush or a roller.

In a preferred embodiment, the object obtained in step b) is in the form of a sheet or a panel, in step c) the coating is applied on at least 80%, more preferably at least 90 wt %, even more preferably at least 95 wt % of the area of the side of the sheet or the panel with the largest surface area.

Preferably in step c) the amount of coating to be applied on the coated part of the object is preferably in the range from 0.08 to 0.23 L/m2, preferably in the range from 0.11 to 0.18 L/m2.

The present invention further relates to the use of the article according to the invention in build and construction for improved first resistance.

Since the article according the invention comprises an object and a layer, wherein the object comprise a thermoplastic composition, wherein the thermoplastic composition comprises a thermoplastic, glass fibers and preferably a flame retardant composition, all the preferred embodiments of thermoplastic, glass fibers, preferred flame retardant composition, thermoplastic composition, the object and the layers apply to the article.

### Experiments

### Materials

PP1: SABIC® PP 595A, propylene homopolymer (Melt flow index of 47 dg/min as measured according to ISO1133 at 230° C./2.16 kg)
PP2: SABIC® PP 83MF10, heterophasic propylene copolymer consisting of propylene homopolymer and propylene-ethylene copolymer (Melt flow index of 1.8 dg/min as measured according to ISO1133 at 230° C./2.16 kg)
LGF: Glass multifilament strand having a diameter D of 19 micron and a tex of 3000 containing 2% by mass of sizing aminosilane agent. LGF was provided in continuous form.
SGF: DS 2200-10P from 3 m, chopped glass fiber having a 10 μm filament diameter, 4 mm length.
Impregnating agent: A highly branched polyethylene wax having density: 890-960 kg/m3, dynamic viscosity: 40-58 mPa·s at 100° C. (ASTM D3236), melting point: 65° C., MW: 400 kg/mol, MWD: 6.8 (Dicera 13082 Paramelt)
Coupling agent: Exxelor PO1020 powder (PP-g-MA) from ExxonMobil: density: 900 kg/m3, melting point: 162° C., MFR: 430 g/10 min at 230° C. and 2.16 kg (testing method: ASTM D1238)
UV stabilizer: Chimasorb 119FL, a hindered amine light stabilizer (HALS)
Thermal stabilizer: Irganox® B 225 commercially available from BASF, blend of 50 wt % tris(2,4-ditert-butylphenyl)phosphite and 50 wt % pentaerythritol tetrakis [3-[3,5-di-tert-butyl-4-hydroxyphenyl]propionate]
Calcium stearate, commercially available LIGA CaSt 860
FR agent: ADK STAB® FP-2500S, a nitrogen/phosphorus-based, halogen-free flame retardant, supplied from ADEKA Polymers Europe.
PC: 50 wt % Lexan PK2870 blended with 50 wt % Lexan 3414. The glass fiber in PC is 20 wt %.
Coating and layer: Envirograf HW01-EP-GC is a coating according to the invention. After drying, Envirograf HW01-EP-GC became the layer according to the invention.
Comparative coating 1: Hensotherm® 910 KS, commercial product from Hensel. A solvent free epoxy fire protection coating. Comparative coating 1 is not a coating according to the invention.
Comparative coating 2: Hensotherm® 490 KS, a water-based intumescent coating system not according to the invention.

### Preparation of Objects in the Examples

To prepare the objects in the examples the following pellets were firstly prepared

Pellet 1: Pellet 1 was prepared in a process according to the examples of WO2009/080281A1 using LGF, Impregnating agent and a thermoplastic composition, wherein the thermoplastic composition consists of PP1, PP2, Coupling agent, UV stabilizer, thermal stabilizer. MFI of the thermoplastic composition in Pellet 1 is 17.2 g/10 min (230° C., 2.16 kg). The average length of Pellet 1 was 15 mm, the LGF in Pellet 1 has essentially the same length as Pellet 1 of 15 mm. The recipe of Pellet 1 is in Table 1.

Pellet 2: Pellet 2 was prepared in a process according to the examples of WO2009/080281A1 using LGF, Impregnating agent and a thermoplastic composition, wherein the thermoplastic composition consists of PP1, PP2, Coupling agent, UV stabilizer, thermal stabilizer, calcium stearate and FR agent. MFI of the thermoplastic composition in Pellet 2 is also 17.2 g/10 min (230° C., 2.16 kg). The length of Pellet 2 was 15 mm, the LGF in Pellet 2 has essentially the same length as Pellet 2 of 15 mm. The recipe of Pellet 2 is in Table 1

Pellet 3: The ingredients of Pellet 3 were introduced into an extruder. The recipe of Pellet 3 is in Table 1.

Pellet 4: The ingredients of Pellet 4 were introduced into an extruder. The recipe of Pellet 4 is in Table 1.

Pellet 5: Pellet 5 was obtained by extruding 50 wt % Lexan PK2870 blended with 50 wt % Lexan 3414.

TABLE 1
Recipes of Pellet 1, 2, 3 and 4

| | Pellet 1 | Pellet 2 | Pellet 3 | Pellet 4 |
|---|---|---|---|---|
| PP1 (wt %) | 41.97 | 25.47 | 25.53 | 16.15 |
| PP2 (wt %) | 23.50 | 14.50 | 42.57 | 26.95 |
| LGF (wt %) | 30.17 | 30.17 | | |
| SGF (wt %) | | | 30.00 | 30.00 |
| Impregnating agent (wt %) | 2.60 | 2.60 | | |
| Coupling agent (wt %) | 1.50 | 1.50 | 1.00 | 1.00 |
| UV stabilizer (wt %) | 0.06 | 0.06 | 0.20 | 0.20 |
| Thermal stabilizer (wt %) | 0.20 | 0.20 | 0.20 | 0.20 |
| Calcium stearate (wt %) | | 0.50 | 0.50 | 0.50 |
| FR agent (wt %) | | 25.00 | | 25.00 |

Then Pellet 1 to 5 were extruded into Object 1 to 5 respectively.

Object 6 was obtained by extruding PP2 directly.

Object 7 was obtained by extruding 75 wt % PP2 with 25 wt % FR agent.

All Objects have dimensions of 1500*500*35 mm.

### Preparation of the Examples

Object 6 was used directly as CE1;
Object 1 was used directly as CE2;
Object 7 was used directly as CE3;
Object 2 was used directly as CE4;

Coating according to the invention (Envirograf HW01-EP-GC) was applied on 1500*500 mm surface of Object 1 to 5 using a roller with an quantity of 1 liter to 8 m2 surface to prepare Ex5, Ex6. CE7, CE8, CE9 Then Object 1 to 5 were dried at room temperature 23° C. 50% relative humidity, 7 days. After drying, the coating became a layer with a thickness of 0.3 mm. The details of the coating and measurement result can be found in Table 2.

### Measurement

All the examples were mounted on a calcium silicate board in vertical position using screws with a surface 1500*500 mm. The other surface of 1500*500 mm was subject to SBI test. The coated surface of Ex5, Ex6, CE7, CE8, CE9 was subject to SBI test and faced with the flame. SBI refers to Single Burning Item test EN 13501-1:2018 The specimen is exposed to a diffusive flame of 30 kW. Combustion gases were collected by an exhaust hood for analysis. This gas analysis made it possible by oxygen depletion to calculate heat release rate from the specimen. Smoke production was assessed by measuring attenuation of a light beam by smoke in the exhaust duct. The burning behavior of the specimen was observed for flame spread, and the occurrence of burning particles and droplets.

### Fiber Length in the Object

A micro CT was used to scan the object to generate a 3D image of the internal structure of the object. A fully automated image processing algorithm detects all length of all the glass fibers in the image. The average fiber length is weight average fiber length was calculated via the formula:

$${L}_{w} = \frac{\sum {l}_{i}^{2}}{\sum {l}_{i}}$$

Where lᵢ is the individual fiber length.

The average length of glass fibers in Object 1, 2 and 3 were respectively: Object 1 L_{w}=1.00 mm, Object 2 L_{w}=0.50 mm, Object 3 L_{w}=0.30 mm.

TABLE 2
Details of examples and SBI measurement result

| | Object | Coating | SBI |
|---|---|---|---|
| CE1 | Object 6 | No | Fail |
| CE2 | Object 1 | No | Fail |
| CE3 | Object 7 | No | Fail |
| CE4 | Object 2 | No | Fail |
| Ex5 | Object 1 | Yes | Pass |
| Ex6 | Object 2 | Yes | Pass |
| CE7 | Object 3 | Yes | Fail |
| CE8 | Object 4 | Yes | Fail |
| CE9 | Object 5 | Yes | Fail |

Clearly only Ex5 and Ex6 according to the invention have passed SBI measurement.

Further comparative examples were prepared by applying Comparative coating 1 and Comparative coating 2 were applied on Objects 1 to 7 respectively in the same manner as the application of the coating according to the invention. After drying at room temperature. 50% relative humidity, 7 days, all 14 further comparative examples were subject to EN 13501-1:2018 test and all failed the test.

1. An article comprising an object and a layer, wherein at least part of the surface of the object is covered by the layer, wherein the object comprises a thermoplastic composition, wherein the thermoplastic composition comprises a thermoplastic and glass fibers wherein the glass fibers have an average length of at least 0.36 mm, wherein the layer comprises compounds comprising moieties derived from melamine and pentaerythritol.

2. The article according to claim 1, wherein the compounds comprising moieties derived from melamine is selected from the group consisting of melamine phosphate, melamine cyanurate, melamine borate, melamine polyphosphate, melamine silicate and combinations thereof.

3. The article according to claim 1, wherein the compounds comprising moieties derived from pentaerythritol is selected from the group consisting of pentaerythritol, dipentaerythritol, tripentaerythritol, polycondensates of pentaerythritol, pentaerythritol-based esters and combinations thereof.

4. The article according to claim 1, wherein the layer further comprises compounds comprising moieties derived from phosphate.

5. The article according to claim 1, wherein the average length of the glass fibers is in the range from 0.39 to 5.45 mm.

6. The article according to claim 1, wherein the amount of glass fiber is in the range from 15 to 56 wt %, based on the total amount of the thermoplastic composition.

7. The article according to claim 1, wherein the thickness of the layer is in the range from 150 to 2450 μm.

8. The article according to claim 1 wherein the amount of the thermoplastic composition is at least 90 wt %, based on the total amount of the object.

9. A process for the preparation of an article comprising the following sequential steps:
a) providing pellets comprising a thermoplastic composition wherein the thermoplastic composition comprises a thermoplastic and glass fibers, wherein the glass fibers have an average length in the range from 10 to 55 mm;
b) shaping the pellets into an object;
c) applying a coating on at least part of the surface of the object, wherein the coating comprises compounds comprising moieties derived from melamine, pentaerythritol.

10. The process according to claim 9 wherein the coating is applied on at least part of the surface of the object using a brush or a roller.

11. The process according to claim 9 wherein the coating comprises 15 to 20 wt % water based on the total amount of the coating.

12. The process according to claim 9 wherein the amount of coating to be applied on the coated part of the object is in the range from 0.08 to 0.23 L/m2.

13. The process according to claim 9, wherein the density of the coating density of coating is from 1080 to 1534 kg/m3, as measured according to ISO 18747-2:2019.

14. The article according to claim 1, wherein the object is in the form of a sheet or a panel wherein the thickness of the sheet or the panel is in the range from 15 to 55 mm.

15. (canceled)

16. The article according to claim 4, wherein the compounds comprising moieties derived from phosphate is selected from the group consisting of guanyl urea phosphate, sodium polyphosphate and combinations thereof.
